(19) United States
(12) Patent Application Publication
(10) Pub. No.: US 2018/0067008 A1
(43) Pub. Date: Mar. 8, 2018

(54) BURIED CAVITY SENSE DIE DIAPHRAGM STOP FOR FORCE SENSORS

(71) Applicant: Honeywell International Inc., Morris Plains, NJ (US)

(72) Inventors: Richard Wade, Worthington, OH (US); Alistair David Bradley, Hilliard, OH (US); Richard Alan Davis, Plano, TX (US); Jason Dennis Patch, Columbus, OH (US)

(21) Appl. No.: 15/260,065

(22) Filed: Sep. 8, 2016

(51) Int. Cl. G01L 9/00

(52) U.S. Cl. CPC G01L 9/0054

(57) ABSTRACT

A pressure sensor may comprise a first wafer comprising a plurality of recesses formed thereon; a second wafer bonded to the first wafer over the plurality of recesses, wherein the second wafer comprises a plurality of sensing diaphragms defined by an area of the second wafer disposed over each recess, and wherein the each recess forms a cavity between the first wafer and the second wafer; one or more sense elements supported by each sensing diaphragm, wherein the at least one sensing diaphragm is configured to contact a surface of the respective cavity to prevent overforce on the at least one sensing diaphragm, and wherein the one or more sense elements on the at least one sensing diaphragm continue to provide an indication of a pressure when the at least one sensing diaphragm is in contact with the surface of the respective cavity.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Pressure sensors are used in a wide variety of applications including, for example, commercial, automotive, aerospace, industrial, and medical applications. Pressure sensors often use a pressure sense die that is mounted to a pressure sensor package using a die attach. The pressure sense die is often configured to detect a pressure of a sensed media by converting mechanical stress induced by the sensed media in a sense diaphragm of the pressure sense die into an electrical output signal. A sensor construction that allows for the downward application of pressure to the sensing die and that also isolates the sensitive components of the pressure sensing die from the media to be sensed may provide a robust pressure sensor that can be used in a variety of environments.

### SUMMARY

In an embodiment, a pressure sensor may comprise a first wafer comprising a plurality of recesses formed thereon; a second wafer bonded to the first wafer over the plurality of recesses, wherein the second wafer comprises a plurality of sensing diaphragms, wherein each sensing diaphragm of the plurality of sensing diaphragms is defined by an area of the second wafer disposed over each recess of the plurality of recesses, and wherein the each recess of the plurality of recesses forms a cavity between the first wafer and the second wafer; one or more sense elements supported by each sensing diaphragm of the plurality of sensing diaphragms, wherein at least one sensing diaphragm of the plurality of sensing diaphragms is configured to flex toward a respective cavity in response to pressure, wherein the at least one sensing diaphragm is configured to contact a surface of the respective cavity to prevent overforce on the at least one sensing diaphragm, and wherein the one or more sense elements on the at least one sensing diaphragm continue to provide an indication of a pressure when the at least one sensing diaphragm is in contact with the surface of the respective cavity.

In an embodiment, a pressure sensor may comprise a first wafer comprising a recess; a second wafer, wherein the first wafer is bonded to the second wafer such that the recess formed in the first wafer creates a cavity between the first wafer and the second wafer; wherein the second wafer comprises a sensing diaphragm defined by a portion of the second wafer disposed over the recess; and one or more sense elements supported by the sensing diaphragm of the second wafer, wherein a depth of the sealed cavity between the first wafer and the second wafer is configured to prevent an overforce on the sensing diaphragm by allowing the sensing diaphragm to contact a surface of the first wafer in the recess, and wherein the one or more sense elements are configured to continue to provide an output when the sensing diaphragm is in contact with the surface of the cavity.

In an embodiment, a method for detecting pressure using a pressure sensor may comprise applying a force to a pressure sensor, the pressure sensor comprising a cavity, wherein the cavity is located between two wafers, wherein a portion of one of the wafers defines a sensing diaphragm, and wherein the pressure sensor comprises one or more sense elements located on the sensing diaphragm; detecting the pressure increase at a first rate while the diaphragm moves freely within the cavity; at least partially contacting the diaphragm to a surface of the cavity; and detecting the pressure increase at a second rate while the diaphragm at least partially contacts the surface of the cavity.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIGS. 1A-1F illustrate the steps of assembling a sensing zone for a pressure sensor according to an embodiment of the disclosure;

FIG. 2 illustrates a cross-sectional view of one or more wafers within a pressure sensor according to an embodiment of the disclosure;

FIG. 3 illustrates a top view of one or more wafers within a pressure sensor according to an embodiment of the disclosure;

FIG. 4 illustrates a graph of the output of pressure sensors according to an embodiment of the disclosure;

FIG. 5 illustrates another graph of the output of pressure sensors according to an embodiment of the disclosure; and

FIG. 6 is a schematic top view of a sense die according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include systems and methods for detecting pressure using a pressure sensor comprising a cavity located between two wafers within the sensor.

As force sensors are developed to fit into smaller and smaller packaging, the challenges faced to achieve high overforce protection levels increase. Typical force sensors or load cells in the market achieve their overforce protection with one or more mechanical features added to the design. In the case of load cells, this may be done by putting a mechanical travel limiter on the beam element that is sensing. However, for load cells and force sensors, smaller packaging may limit the ability to include mechanical features (such as stop or control elements).

Embodiments of the disclosure provide overforce protection within the structure of the sensor itself, wherein the structure may not rely on any final assembly controls, but rather makes use of the precise wafer bonding process. Embodiments may include a first (handle or constraint) wafer that is bonded to a second (device) wafer. The device wafer may contain the Wheatstone bridge and sensing elements and the diaphragm that moves under an applied force. The device wafer may be bonded to the handle wafer. The handle wafer may comprise a shallow cavity created on it which can be vented or not vented. The device wafer diaphragm, when displaced by the operating force, moves down into the shallow cavity of the handle wafer. As the load continues to increase beyond a first (operating) force range and into a second (proof) force range, the diaphragm approaches the bottom surface of the shallow cavity and eventually contacts the bottom surface and may stop moving. When the diaphragm contacts the bottom surface of the cavity, this may transfer the entire load from the applied force to the handle wafer and may limit the stress on the diaphragm, thereby preventing overforce (and possible damage) of the diaphragm.

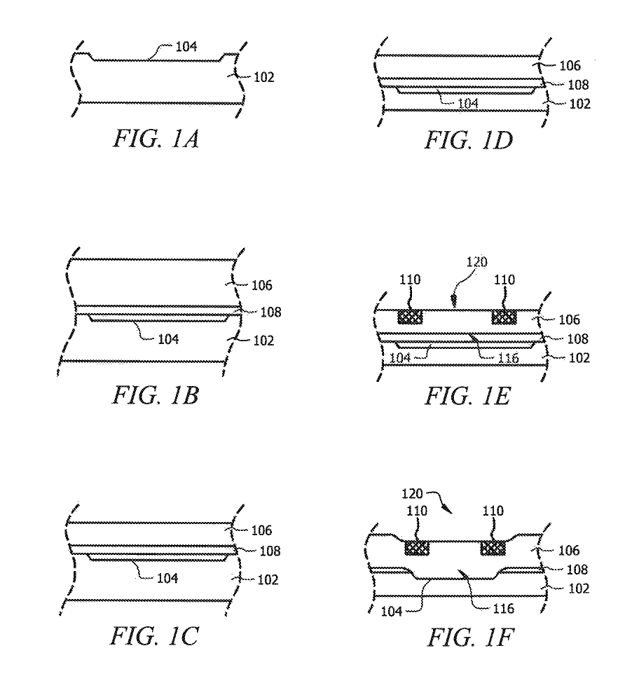

Referring to FIG. 1A, a detailed view of the wafers assembled within a pressure sensor is shown. A first wafer 102 may be formed, where the first wafer 102 may comprise a “handle” wafer. In some embodiments, a cavity 104 may be formed on the top surface of the first wafer 102. The cavity allows for a limited movement of the diaphragm, and the back surface of the cavity 104 can serve as a diaphragm stop while allowing for a signal span across the expected full scale load on the sensor. The depth of the cavity 104 can be tightly controlled to ensure that the diaphragm stop happens in the over force while preventing or reducing the likelihood of a diaphragm break.

As shown in FIG. 1B, a second wafer 106 may be bonded to the top surface of the first wafer 102, where the cavity 104 is located between the first wafer 102 and the second wafer 106. In some embodiments, the second wafer 106 may comprise a “device” wafer.

The second wafer 106, (wafer “A”) is processed with a silicon oxide layer, to facilitate silicon wafer bonding or with whatever processing is needed to facilitate the wafer bonding process. The wafer could be ground prior to the bonding or ground after the bonding. Once the two wafers are bonded, the second wafer 106 can be processed to add the metal layers to the topside and the piezoresistive sensing elements or other sensing technology, where the sensing elements can be arranged in a half or full Wheatstone bridge in some embodiments. Once this processing is done, the second wafer 106 can be diced and used, or can be further ground on the first wafer 102 (or handle wafer) side to provide a consistent height for the sense die. Since force sensors are very sensitive to the overall coupling height, a consistent coupling height can be useful. The die can then be bonded to a substrate and coupling elements (e.g., wire bonds, solder balls, etc.) can be brought into contact with the sensor to couple the sensor to external circuitry to form the sensor.

In some embodiments, a silicon oxide layer 108 may be configured to bond the second wafer 106 to the first wafer 102. Alternatively, another material and/or method may be used to bond the second wafer 106 to the first wafer 102. In some embodiments, as shown in FIG. 1C, a portion of the second wafer 106 may be removed, possibly by grinding, milling, etching, or another process, to decrease the thickness of the second wafer 106. Similarly, as shown in FIG. 1D, a portion of the first wafer 102 may be removed, possibly by grinding, milling, etching, or another process, to decrease the thickness of the first wafer 102. After the wafers 102 and 106 have been bonded and formed to be the desired thickness, additional elements may be assembled onto one or both of the wafers 102 and 106. For example, as shown in FIG. 1E, one or more sense elements 110 may be assembled onto the second wafer 106, wherein the sense elements 110 may be located near the cavity 104 of the first wafer 102. In some embodiments, the combination of the cavity 104 and the sense elements 110 may form a sensing zone 120 in the wafers 102 and 106. In some embodiments, the cavity 104 may be sized such that the pressure sensor is configured to measure pressure less than approximately 15 psi.

In some embodiments, the cavity 104 may have a vacuum reference pressure, or any other suitable reference pressure as desired. When so provided, the second wafer 106 may form a sensing diaphragm 116 that is referenced to the reference pressure in the cavity 104. The sensing diaphragm 116 may be stressed and/or deformed in response to an applied pressure by the media. This stress and/or deformation can be detected by the one or more sense elements 110 on or embedded within the sensing diaphragm 116.

In some embodiments, starting with the first wafer 102 having a cavity 104, standard pattern, implant, diffusion, and/or metal interconnect processes may be used to form one or more elements on the upper surface of the second wafer 106. For example, one or more piezoresistive sense elements 110 may be formed on the sensing diaphragm 116. The piezoresistive sense elements 110 may be configured to have an electrical resistance that varies according to an applied mechanical stress (e.g. deflection of pressure sensing diaphragm 116). The piezoresistive sense elements 110 can thus be used to convert the applied pressure into an electrical signal. In some instances, the piezoresistive components may include a silicon piezoresistive material; however, other non-silicon materials may be used. In some cases, the piezoresistive sense elements 110 may be connected in a Wheatstone bridge configuration (full or half bridge). It will be generally understood that the piezoresistive sense elements 110 are only one example of a pressure sensing element, and it is contemplated that any other suitable sensing elements may be used, as desired.

FIG. 1F illustrates the sensing diaphragm deflecting into the cavity 104 due to applied pressure, and contacting the bottom surface of the cavity 104. The cavity 104 may prevent overforce of the sensing diaphragm 116, thereby preventing damage to the sensing diaphragm 116.

In use, a pressure can be applied across the sensor between the cavity 104 and an opposite side of the second wafer 106. In response to the differential pressure, the sensing diaphragm 116 and/or the second wafer 106 may deflect into the cavity 104. As the sensing diaphragm 116 deflects into the cavity 104, the resistance of one or more of the sense elements 110 may change to provide an indication of the degree of deflection of the second wafer 106. In general, the sensing diaphragm 116 or second wafer 106 can initially deflect freely into the cavity 104. When the sensing diaphragm 116 or second wafer 106 sufficiently deflects, the sensing diaphragm 116 or second wafer 106 can contact a surface of the cavity 104. The surface of the cavity 104 may then serve to limit further motion of the portion of the sensing diaphragm 116 or second wafer 106 contacting the surface of the cavity 104. Further increase in pressure or force on the sensing diaphragm 116 or second wafer 106 may continue to deflect or deform the sensing diaphragm 116 towards the cavity 104, which can result in the sensing diaphragm 116 or second wafer 106 flattening out on the surface of the cavity 104. During this process, the resistance of one or more of the sensing elements 110 may continue to change, but the change may occur at a different rate than during free motion of the sensing diaphragm 116 or second wafer 106. At a high enough force, the sensing diaphragm 116 or second wafer 106 may contact the surface of the cavity 104 over a sufficient surface area to effectively prevent further deflection. The support by the surface of the cavity 104 can result in force detection having two regions or rates, a first rate or detection range during free motion of the sensing diaphragm 116 or second wafer 106 and a second rate or detection range while the sensing diaphragm 116 or second wafer 106 contacts and continues to deflect into contact with the surface of the cavity 104.

FIG. 2 illustrates an embodiment where the pressure sensor 100 comprises a plurality of sensing zones 120. The view in FIG. 2 shows a cross-sectional view of the wafer elements of the pressure sensor 100. The first wafer 102 may comprise a plurality of cavities 104, and the second wafer 106 may comprise a plurality of sense elements 110. The plurality of sensing zones 120 created by the cavities 104 and sense elements 110 may allow for detailed and precise pressure sensing across the pressure sensor 100. In some embodiments, the pressure sensor 100 comprises between approximately 120 and 140 sensing zones 120.

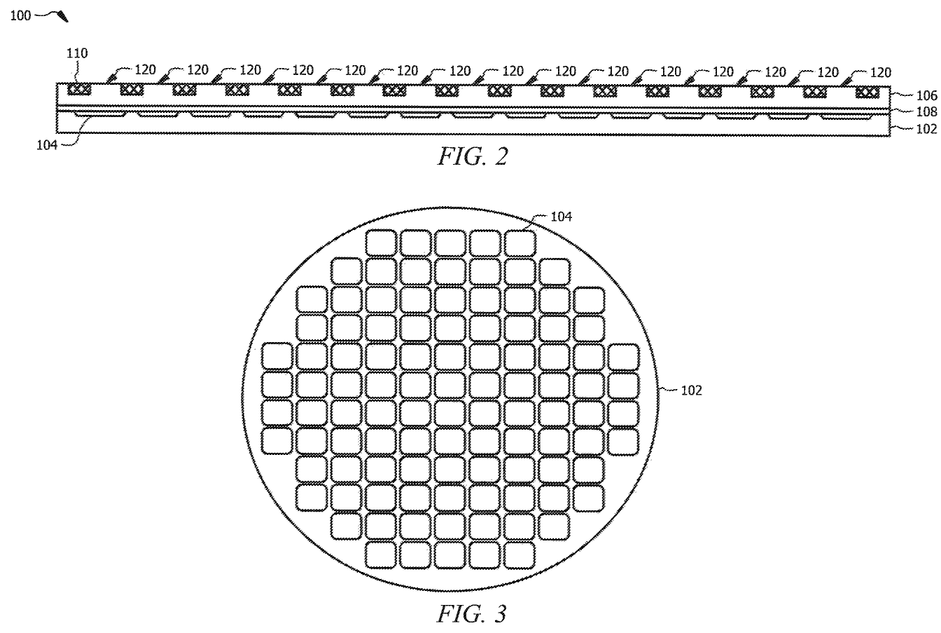

FIG. 3 illustrates a top view of the first wafer 102 as shown in FIG. 2. The first wafer 102 may comprise a plurality of cavities 104 throughout the surface of the first wafer 102. In some embodiments, the first wafer 102 may comprise approximately 120 cavities 104. In some embodiments, the diameter of the first wafer 102 (and possibly the second wafer 106) may be less than approximately 8 inches.

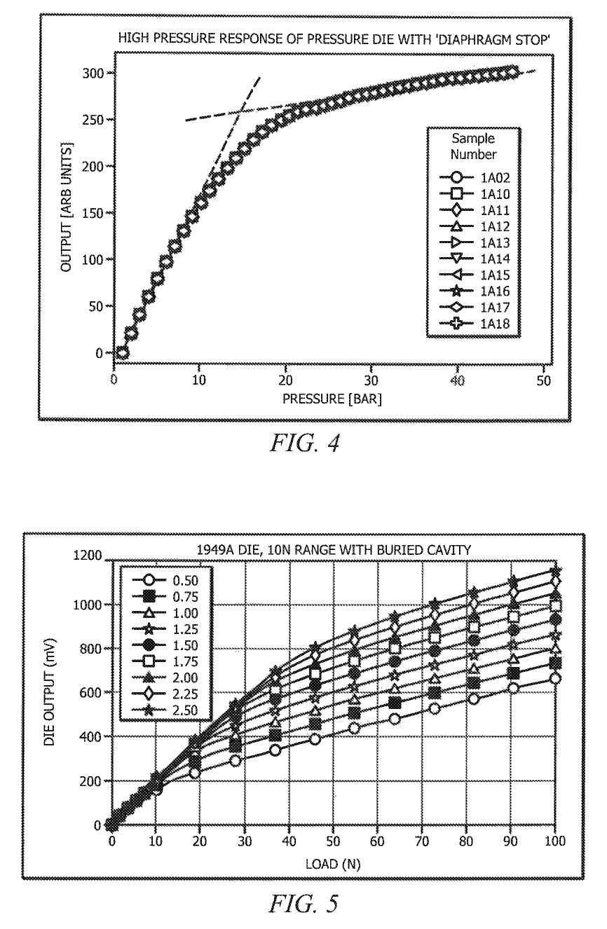

FIG. 4 illustrates an example of the output of prototype pressure sensors which have a buried cavity acting as a diaphragm stop as described above. The dashed lines approximately illustrate a first slope for a first section of the graph, where the center of the diaphragm is completely free to move within the cavity, and a second slope for a second section of the graph (which may be less than the first slope), where an increasingly large area in the center of the diaphragm comes into contact with the bottom of the cavity. The graph shows the data for 10 different samples with consistent behavior for all of them. These separate sections of pressure measurement may be output from the sensor and may provide additional information about the pressure applied to the sensor.

FIG. 5 illustrates another example of the output of pressure sensors, where the depth of the cavity was varied between the sensors. The graph shows the sensor output versus load for a series of cavity depths. The depths on the chart vary between 0.50 and 2.50 microns. As was illustrated in the graph of FIG. 4, the sensor outputs contain a first section with a first slope and a second section with a second slope.

A pressure sensor as described above may be used in many different applications. For example, the pressure sensor may be used to monitor liquid levels in the medical field, such as in medicines that are given to a patient intravenously. The pressure sensor may be configured to monitor the liquid levels in two different reading zones (as described above), wherein when the liquid levels are higher, the pressure may be higher, and therefore the diaphragm may be contacting the bottom surface of the cavity. Then, as the liquid level decreases, the pressure may also decrease, and the diaphragm may contract upward away from the bottom surface of the cavity, entering the second zone of pressure readings. In some embodiments, the switch from the first zone to the second zone may indicate to a user that the liquid level has reached a certain point. The detailed information provided by these readings may be useful to the person monitoring the levels.

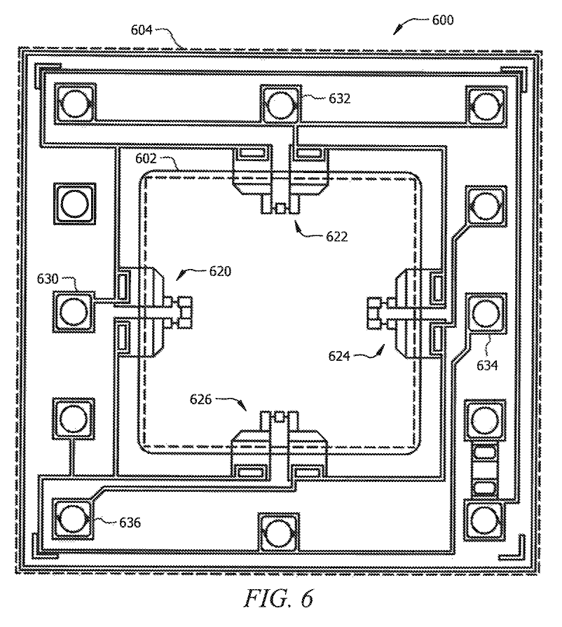

As shown in FIG. 6, a sense die 600 (which may be similar to the sensor 100 described above) may have one or more sensing elements 620, 622, 624, 626 disposed on or adjacent to the diaphragm 602, such as piezoresistive sensing elements or components formed using suitable fabrication or printing techniques. For example, starting with the silicon sense die 600, standard pattern, implant, diffusion, and/or metal interconnect processes may be used to form one or more elements 620, 622, 624, 626 on a surface 603, 605 of the silicon die. For example, one or more piezoresisitive sense elements 620, 622, 624, 626 may be formed on the diaphragm 602. The piezoresisitive sense elements 620, 622, 624, 626 may be configured to have an electrical resistance that varies according to an applied mechanical stress (e.g. deflection of the diaphragm 602). The piezoresisitive sense elements 620, 622, 624, 626 can thus be used to convert the applied force or pressure into an electrical signal. In some instances, the piezoresisitive components may include a silicon piezoresistive material; however, other non-silicon materials may be used.

One or more bond pads 630, 632, 634, 636 may be formed on the upper surface 603 of the silicon die 600 and adjacent to the diaphragm 602. Metal, diffusion, or other interconnects may be provided to interconnect the one or more piezoresistive sensor elements 620, 622, 624, 626 and the one or more bond pads 630, 632, 634, 636. As shown in FIG. 6, one or more of the piezoresistive sensor elements 620, 622, 624, 626 can be electrically coupled to one or more of the bond pads 630, 632, 634, 636.

In a first embodiment, a pressure sensor may comprise a first wafer comprising a plurality of recesses formed thereon; a second wafer bonded to the first wafer over the plurality of recesses, wherein the second wafer comprises a plurality of sensing diaphragms, wherein each sensing diaphragm of the plurality of sensing diaphragms is defined by an area of the second wafer disposed over each recess of the plurality of recesses, and wherein the each recess of the plurality of recesses forms a cavity between the first wafer and the second wafer; one or more sense elements supported by each sensing diaphragm of the plurality of sensing diaphragms, wherein at least one sensing diaphragm of the plurality of sensing diaphragms is configured to flex toward a respective cavity in response to pressure, wherein the at least one sensing diaphragm is configured to contact a surface of the respective cavity to prevent overforce on the at least one sensing diaphragm, and wherein the one or more sense elements on the at least one sensing diaphragm continue to provide an indication of a pressure when the at least one sensing diaphragm is in contact with the surface of the respective cavity.

A second embodiment can include the sensor of the first embodiment, wherein the one or more sense elements on the at least one sensing diaphragm are configured to measure a pressure change at a first rate before the diaphragm contacts the surface of the respective cavity, and measure the pressure change at a second rate while the at least one sensing diaphragm is in contact with the surface of the respective cavity.

A third embodiment can include the sensor of the first or second embodiments, wherein the depth of the cavity is less than approximately 2.5 microns.

A fourth embodiment can include the sensor of any of the first to third embodiments, wherein the pressure sensor comprises between approximately 120 and 140 recesses.

A fifth embodiment can include the sensor of any of the first to fourth embodiments, wherein the pressure sensor is configured to measure pressures less than approximately 15 psi.

A sixth embodiment can include the sensor of any of the first to fifth embodiments, wherein the diameter of the first wafer is less than approximately 8 inches.

A seventh embodiment can include the sensor of any of the first to sixth embodiments, further comprising a silicon oxide bonding layer located between the first wafer and the second wafer.

An eighth embodiment can include the sensor of any of the first to seventh embodiments, wherein each cavity of the plurality of cavities provides an absolute reference for the sensor.

In a ninth embodiment, a pressure sensor may comprise a first wafer comprising a recess, a second wafer, wherein the first wafer is bonded to the second wafer such that the recess formed in the first wafer creates a cavity between the first wafer and the second wafer; wherein the second wafer comprises a sensing diaphragm defined by a portion of the second wafer disposed over the recess; and one or more sense elements supported by the sensing diaphragm of the second wafer, wherein a depth of the sealed cavity between the first wafer and the second wafer is configured to prevent an overforce on the sensing diaphragm by allowing the sensing diaphragm to contact a surface of the first wafer in the recess, and wherein the one or more sense elements are configured to continue to provide an output when the sensing diaphragm is in contact with the surface of the cavity.

A tenth embodiment can include the sensor of the ninth embodiment, wherein the one or more sense elements and the sensing diaphragm are configured to provide an output that increases at a first rate while the sensing diaphragm moves freely within the cavity and increases at a second rate after the sensing diaphragm is in contact with the surface of the cavity.

An eleventh embodiment can include the sensor of the ninth or tenth embodiments, wherein the depth of the cavity is less than approximately 2.5 microns.

A twelfth embodiment can include the sensor of any of the ninth to eleventh embodiments, wherein the depth of the cavity is approximately 1 micron.

A thirteenth embodiment can include the sensor of any of the ninth to twelfth embodiments, wherein the depth of the cavity is between about 0.5 microns and about 2.5 microns.

A fourteenth embodiment can include the sensor of the ninth to thirteenth embodiments, further comprising a silicon oxide bonding layer located between the first wafer and the second wafer.

A fifteenth embodiment can include the sensor of the any of the eighth to fourteenth embodiments, wherein the cavity provides an absolute reference pressure for the sensor.

In a sixteenth embodiment, a method for detecting pressure using a pressure sensor may comprise applying a force to a pressure sensor, the pressure sensor comprising a cavity, wherein the cavity is located between two wafers, wherein a portion of one of the wafers defines a sensing diaphragm, and wherein the pressure sensor comprises one or more sense elements located on the sensing diaphragm; detecting the pressure increase at a first rate while the sensing diaphragm moves freely within the cavity; at least partially contacting the sensing diaphragm to a surface of the cavity; and detecting the pressure increase at a second rate while the sensing diaphragm at least partially contacts the surface of the cavity.

A seventeenth embodiment can include the method of the sixteenth embodiment, wherein the cavity comprises a sealed cavity, and wherein the method further comprises providing an absolute pressure reference for the sensor via the sealed cavity.

An eighteenth embodiment can include the method of the sixteenth or seventeenth embodiments, wherein the cavity comprises a vented cavity, and wherein the method further comprises providing a pressure reference for the sensor via the vented cavity.

A nineteenth embodiment can include the method of any of the sixteenth to eighteenth embodiments, further comprising assembling the pressure sensor, wherein assembling comprises creating a recess in the top surface of a first wafer; bonding a second wafer over the recess in the top surface of the first wafer; and applying sense elements to a surface of the second wafer.

A twentieth embodiment can include the method of any of the sixteenth to nineteenth embodiments, wherein the depth of the cavity is less than approximately 2.5 microns.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification, and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A pressure sensor comprising:
a first wafer comprising a plurality of recesses formed thereon;
a second wafer bonded to the first wafer over the plurality of recesses, wherein the second wafer comprises a plurality of sensing diaphragms, wherein each sensing diaphragm of the plurality of sensing diaphragms is defined by an area of the second wafer disposed over each recess of the plurality of recesses, and wherein the each recess of the plurality of recesses forms a cavity between the first wafer and the second wafer;
one or more sense elements supported by each sensing diaphragm of the plurality of sensing diaphragms, wherein at least one sensing diaphragm of the plurality of sensing diaphragms is configured to flex toward a respective cavity in response to pressure, wherein the at least one sensing diaphragm is configured to contact a surface of the respective cavity to prevent overforce on the at least one sensing diaphragm, and wherein the one or more sense elements on the at least one sensing diaphragm continue to provide an indication of a pressure when the at least one sensing diaphragm is in contact with the surface of the respective cavity.

2. The pressure sensor of claim 1, wherein the one or more sense elements on the at least one sensing diaphragm are configured to measure a pressure change at a first rate before the diaphragm contacts the surface of the respective cavity, and measure the pressure change at a second rate while the at least one sensing diaphragm is in contact with the surface of the respective cavity.

3. The pressure sensor of claim 1, wherein a depth of the cavity is less than approximately 2.5 microns.

4. The pressure sensor of claim 1, wherein the pressure sensor comprises between approximately 120 and 140 recesses.

5. The pressure sensor of claim 1, wherein the pressure sensor is configured to measure pressures less than approximately 15 psi.

6. The pressure sensor of claim 1, wherein the diameter of the first wafer is less than approximately 8 inches.

7. The pressure sensor of claim 1, further comprising a silicon oxide bonding layer located between the first wafer and the second wafer.

8. The pressure sensor of claim 1, wherein each cavity of the plurality of cavities provides an absolute reference for the sensor.

9. A pressure sensor comprising:
a first wafer comprising a recess;
a second wafer, wherein the first wafer is bonded to the second wafer such that the recess formed in the first wafer creates a cavity between the first wafer and the second wafer;
wherein the second wafer comprises a sensing diaphragm defined by a portion of the second wafer disposed over the recess; and
one or more sense elements supported by the sensing diaphragm of the second wafer, wherein a depth of the sealed cavity between the first wafer and the second wafer is configured to prevent an overforce on the sensing diaphragm by allowing the sensing diaphragm to contact a surface of the first wafer in the recess, and
wherein the one or more sense elements are configured to continue to provide an output when the sensing diaphragm is in contact with the surface of the cavity.

10. The pressure sensor of claim 9, wherein the one or more sense elements and the sensing diaphragm are configured to provide an output that increases at a first rate while the sensing diaphragm moves freely within the cavity and increases at a second rate after the sensing diaphragm is in contact with the surface of the cavity.

11. The pressure sensor of claim 9, wherein the depth of the cavity is less than about 2.5 microns.

12. The pressure sensor of claim 9, wherein the depth of the cavity is about 1 micron.

13. The pressure sensor of claim 9, wherein the depth of the cavity is between about 0.5 microns and about 2.5 microns.

14. The pressure sensor of claim 9, further comprising a silicon oxide bonding layer located between the first wafer and the second wafer.

15. The pressure sensor of claim 9, wherein the cavity provides an absolute reference pressure for the sensor.

16. A method for detecting pressure using a pressure sensor, the method comprising:
applying a force to the pressure sensor, the pressure sensor comprising a cavity, wherein the cavity is located between two wafers, wherein a portion of one of the wafers defines a sensing diaphragm, and wherein the pressure sensor comprises one or more sense elements located on the sensing diaphragm;
detecting the pressure increase at a first rate while the sensing diaphragm moves freely within the cavity;
at least partially contacting the sensing diaphragm to a surface of the cavity; and
detecting the pressure increase at a second rate while the sensing diaphragm at least partially contacts the surface of the cavity.

17. The method of claim 16, wherein the cavity comprises a sealed cavity, and wherein the method further comprises providing an absolute pressure reference for the sensor via the sealed cavity.

18. The method of claim 16, wherein the cavity comprises a vented cavity, and wherein the method further comprises providing a pressure reference for the sensor via the vented cavity.

19. The method of claim 16, further comprising assembling the pressure sensor, wherein assembling comprises:
creating a recess in a top surface of a first wafer;
bonding a second wafer over the recess in the top surface of the first wafer; and
applying sense elements to a surface of the second wafer.

20. The method of claim 16, wherein the depth of the cavity is less than about 2.5 microns.
